(19) United States
(12) Patent Application Publication
(10) Pub. No.: US 2007/0158317 A1
(43) Pub. Date: Jul. 12, 2007

(54) Thin flat glass for display purposes and method of cutting the thin flat glass into display sheets

(76) Inventors: Peter Brix, Mainz (DE); Thilo Zachau, Buerstadt (DE); Wolfram Beier, Essenheim (DE); Rainer Liebald, Nauheim (DE); Dirk Sprenger, Stadecken-Elsheim (DE)

Correspondence Address: STRIKER, STRIKER & STENBY, 103 EAST NECK ROAD, HUNTINGTON, NY, 11743, US

(21) Appl. No.: 11/480,621

(22) Filed: Jul. 3, 2006

(30) Foreign Application Priority Data
Jul. 6, 2005 (DE) 10 2005 031 599.2
Jun. 16, 2006 (DE) 10 2006 029 073.9

(51) Int. Cl. B23K 26/38; B23K 26/00; B29C 35/08

(52) U.S. Cl. 219/121.72; 264/400

(57) ABSTRACT

To improve the cutting properties, especially the cutting rate, of thin flat glass by means of a laser cutting beam from a Nd:YAG solid-state laser, the flat glass is provided during its manufacture with at least one additive ingredient that effectively absorbs radiation at a wavelength of 1.064 μm. Preferably the additive ingredient is preferably samarium oxide (Sm₂O₃). A method of cutting through a flat glass sheet whose composition contains at least one additive ingredient that absorbs a significant amount of radiation at a wavelength of 1.064 μm, which includes cutting the flat glass sheet with the focused radiation of a Nd:YAG laser, is also part of the present invention.

### CROSS-REFERENCE

The invention described and claimed hereinbelow is also described, at least in part, in German Patent Application DE 10 2005 031 599.2-46 filed on Jul. 6, 2005 and, at least in part, in another German Patent Application filed on Jun. 16, 2006. The foregoing German Patent Applications provide the basis for a claim of priority of invention of the invention described hereinbelow based on 35 U.S.C. 119 and their subject matter is hereby incorporated by reference.

### BACKGROUND OF THE INVENTION

1. The Field of the Invention

The present invention relates to a thin flat glass for display purposes with improved cutting properties for cutting by means of a laser beam, especially by a cutting beam from a ND:YAG laser. The invention also relates to a method for cutting the thin flat glass into display sheets.

2. Related Art

Thin flat glass sheets of the greatest variety of sizes and configurations are required for numerous applications. Mobile phone displays, flat screens for TV and computer and for digital cameras and camcorders are especially important actual applications of thin flat glass for display purpose. The thickness of this sort of display glass is on the order of mm, with a tendency to smaller thicknesses down to 0.2 mm.

Conventional cutting methods for flat glass are based on first scratching or scoring the glass by means of a diamond or a cutting wheel with a metal knife edge and subsequently breaking the glass along the weakened scratch or score line produced thereby by applying an exterior mechanical force (score-break method). In this method particles (splitter) are released from the surface, which can deposit on the glass and which can lead e.g. to scratches there. Similarly so-called ear-like or shell-like deposits can arise on the cut edge, which leads to a non-planar glass edge. Furthermore the micro-cracks produced by the scoring at the cut edge lead to a reduction in mechanical structural strength or to mechanical stresses, i.e. to an increased danger of breaking of the cut structure. The broken edge must subsequently be ground and polished. Because of that the glass substrate requires careful cleaning.

Laser cutting techniques can replace these expensive mechanical procedures, which include the grinding and cutting steps, so that the cleaning associated with the glass cutting can be avoided. The laser cutting method includes guiding a focused laser beam along the cutting line by means of a scanner usually with a following cooling spot, so that thermo-mechanical stresses are induced by the local heating with the focused laser beam and following cooling until the breaking strength of the material is exceeded. It is indeed possible to score the glass first with the laser beam in order to mechanically break it subsequently with an initial crack or starting score applied mechanically and also to immediately completely severe or cut the glass mechanically with the laser beam. These laser cutting techniques or methods are described in several prior art references, for example, EP 0 872 303 A2, U.S. Pat. No. 5,609,254, and EP 0 062 484 A1, which are expressly included herein by reference. Thus these references do not need to be described in more detail herein.

Glass sheets can be successfully cut by laser-induced stresses with a CO₂ laser. The laser beam of the desired shape and the laser energy produced by it leads to a local heating of the glass along the cutting line and to a partial vaporization of the glass components. Thermal stresses, which are produced in the glass by an immediate cooling, lead to cracking of the glass sheet at the desired positions. As in the conventional score-and-break method both process steps, score and break, are required when using the CO₂ laser. However since the edge quality is very much improved, the grinding and washing steps required in the conventional mechanical cutting procedure can be eliminated.

Another sort of laser cutting method can be used when cutting with solid-state lasers, especially with the Nd:YAG laser using MLBA (Multiple Laser Beam Absorption). This sort of technique is described for example in EP 1 341 730 B1. In contrast to the radiation produce by the CO₂ laser at 10.6 μm in the far IR the radiation, which is produced by the Nd:YAG laser, is at 1.064 μm in the near IR range, which is only absorbed and converted into heat to a slight extent. However the absorbed radiation energy can be multiplied by an optical system, which reflects the beam many times through the glass, which leads to local heating and expansion. Thermal stress induced by this process is increased until it reaches the critical stress limit for the glass. The resulting stress-induced score or crack can be guided in a controlled manner with the laser. Since the MLBA method can result in elimination of the subsequent process steps in the conventional breaking procedure, the glass material is completely cut in only one working step. The desired cutting edge quality is comparable with the ground and polished glass edge produced by the conventional process, because the micro-cracks and glass splitter are completely avoided. Since the cleaning of the glass product after a grinding and polishing process is eliminated, not only process time, but also required apparatus, plant space and cleaning materials are saved. Higher structural strength than in conventional glass cutting can be achieved by elimination of the micro-cracks or splitters. Not only potassium-sodium glass and borosilicate glass, but also coated, chemically etched and chemically pre-stressed glass may be successfully cut with a thickness of 0.3 mm to 12 mm. While the radiation of a CO₂ laser of wavelength 10.6 μm is absorbed by all types of glass in the first surface layers so that a subsequent mechanical breaking step is necessary, only very little absorption of the radiation of a Nd:YAG laser occurs within the glass. In the known MBLA method a sufficient energy input efficiency occurs at the same position by multiple passes through the glass because of this reduced or small absorption of normal glass for light of wavelength at 1.064 μm. The required optics cooperates with a mirror, which is mounted under the glass sheet and passes the laser light back through the glass again. According to the relationship expressed by formula 1:

$$- ln {τ}_{i} = ( {ɛ}_{0} + {\sum }_{i = 1}^{n} {ɛ}_{l} {c}_{l} ) d , \qquad ( 1 )$$

the absorption−ln τᵢ at a predetermined wavelength (τₗ is the internal transmission of the glass) depends on the thickness of the glass sample, the extinction coefficient of the base glass ε₀ and the extinction coefficients εₗ of one or more glass ingredients of concentration cᵢ, which were added to the base glass. In the MBLA method a sufficiently high absorption is achieved by a predetermined planed increase in the optical path, which corresponds to an increase of the parameter d. With very small glass thickness, e.g. 0.7 mm for sheets used in display applications, very many passes (reflections of the laser beam) are required in order to guarantee a sufficient absorption for the glass cutting. The heating up of the cut edge however takes an increased amount of time, which limits the process times for cutting and thus the efficiency of the manufacturing method in a disadvantageous manner.

### SUMMARY OF THE INVENTION

Thus it is an object of the present invention to provide thin flat glass of the above-described type for display purposes, so that the thin flat glass is more rapidly heated up with a Nd:YAG laser and in the MBLA method than thin flat glass of the prior art so that it may be cut more rapidly.

According to the present invention the thin flat glass for display purposes contains at least one additive ingredient, which effectively absorbs radiation of a wavelength of 1.064 μm, in order to improve its cutability by a laser beam, especially a laser beam of the foregoing wavelength.

As experiments have shown, even additions of additive ingredients in small amounts to glass improve absorption of the laser energy, especially in the case of ND:YAG laser, into the glass, which leads to a more rapid heat-up of the cutting line and thus finally to a more rapid cutting process. This is especially desired for the TFT display glass sheets made of borosilicate glass (TFT thin-film transistor), since generation of the thermal stresses required for cutting is considerably more difficult than e.g. with the comparatively thicker (several millimeters) and more expandable (about 9 ppm/K) potassium-sodium glasses, because of the typically small glass thickness of only 0.7 mm and small thermal expansion coefficient of about 3 ppm/K.

An effective absorption of radiation with a wavelength of 1.064 μm means that the absorption by the additive ingredients is greater than or equal to 0.001 (i.e. 0.1%). However radiation absorption at 1064 nm of at least 0.01 (1%) is preferred.

According to a further embodiment of the invention the additive ingredients comprise samarium oxide, Sm₂O₃, i.e. the further embodiment comprises the use of samarium oxide as auxiliary agent in flat glass for improving the cutting speed and other cutting properties of the flat glass for cutting with a laser beam from a Nd:YAG laser. It is already sufficient to add from 0.001 to 5 percent by weight of samarium oxide in order to significantly improve the cutting properties of the flat glass for laser cutting with a Nd:YAG laser.

Samarium is a chemical element in the periodic system with a symbol Sm and an atomic number of 62. This lustrous silvery metal belongs to the lanthanide group and is a rare earth metal. It reacts with oxygen to form the so-called samarium sesquioxide Sm₂O₃.

Samarium is used for many applications in Engineering. According to Wikipedia, the free Internet Encyclopedia, samarium oxide, among other things, is added to optical glass to absorption of infrared light and provides filter action. However this Wikipedia Encyclopedia reference does not provide any hint or suggestion of the improvement in cutting speed and other cutting properties for cutting with a Nd:YAG laser that is obtained by increasing laser heating due to adding samarium oxide to the flat glass.

Samarium is also added to glasses in order to improve the image contrast in the glass. U.S. Pat. No. 4,769,347 for example describes a colored glass for the display screen of a color picture tube, which contains Sm₂O₃ in amounts up to 3% by weight in order to improve the image contrast. The reduced absorption intensity of the glass thus doped and additionally with added Er₂O₃ is thus employed. JP 61083645 A describes a samarium-containing glass composition for binoculars with increased contrast, in which the samarium is especially used as a coloring component.

U.S. Pat. No. 3,216,308 describes a glass absorbing neutrons containing from 2 to 25% by weight of a samarium additive to improve the amount of neutron absorption.

Samarium-containing glasses are used for so-called flow tubes of Nd:YAG lasers for attenuating the laser radiation with a wavelength of 1.064 μm, which is emitted transverse to the YAG-rod long axis. Also it has a filtering effect and not a targeted heating in the glass.

Finally samarium-containing glasses are under investigation for use in direct writing of optical fiber guides or light guides in glass blocks during procedures for miniaturizing optical circuits, since the valence of samarium ions in glass in very small glass bodies can be changed reversibly by laser radiation. A spectral hole burned in samarium-containing glasses is permanent and can be used for holographic optical memories.

The features according to the invention are especially advantageous for improving the cutting of alkali-free flat glass.

According to an especially preferred embodiment of the invention the flat glass is an alkali free borosilicate glass having a composition, in weight percent on the basis of oxide content, of:

| | |
|---|---|
| SiO₂ | 40 to 70 |
| Al₂O₃ | 6 to 25 |
| B₂O₃ | 5 to 20 |
| MgO | 0 to 5 |
| CaO | 0 to 15 |
| SrO | 0 to 10 |
| BaO | 0 to 30 |
| ZnO | 0 to 10 |
| TiO₂ | 0 to 3 |
| CeO₂ | 0 to 2 |
| MoO₃ | 0 to 1 |
| Yb₂O₃ | 0 to 2 |
| Sm₂O₃ | 0.001 to 5. |

In order to determine the extent of the absorption increase after addition of a predetermined amount of an additive ingredient, here Sm₂O₃, absorbing at wavelengths of 1064 nm in the glass to be cut into pieces, eight examples of aluminoborosilicate glass with different compositions according to Table I and Table II were melted and spectroscopic measurement of the color location and transmission of the examples were performed. The results are illustrated in FIGS. 1 and 2.

### BRIEF DESCRIPTION OF THE DRAWING

The objects, features and advantages of the invention will now be illustrated in more detail with the aid of the following description of the examples, with reference to the accompanying figures in which:

FIG. 1 is a graphical illustration showing the dependence of the maximum cutting rate on the Sm₂O₃ content of the glass for radiation of two different wavelengths; and

FIG. 2 is a graphical illustration showing the influence of the internal transmission on the maximum achievable cutting rate.

### EXAMPLES

The borosilicate glasses were made by melting the raw materials with the compositions listed in Table I at a temperature of 1620° C. in a gas-fired quartz vessel for 120 minutes. The commercially obtained raw materials had the compositions listed in Table I, and were essentially alkali metal free apart from the inevitably present impurities. The melt was refined for 90 minutes at the temperature of 1620° C. and then poured into an inductively heated platinum crucible or vessel. The melt was stirred for 45 minutes at 1520° C. in order to homogenize it The poured glass block was cooled at 730° C. at a rate of 20° C./min.

TABLE I
FLAT GLASS COMPOSITIONS AND PROPERTIES

| | Example 1 | Example 2 | Example 3 | Example 4 |
|---|---|---|---|---|
| SiO₂ | 61.15 | 60.15 | 60.15 | 60.15 |
| B₂O₃ | 9.75 | 9.75 | 9.75 | 9.75 |
| Al₂O₃ | 14.90 | 14.90 | 14.90 | 14.90 |
| MgO | 2.80 | 2.80 | 2.80 | 2.80 |
| CaO | 5.00 | 5.00 | 5.00 | 5.00 |
| BaO | 3.20 | 3.20 | 3.20 | 3.20 |
| TiO₂ | 2.00 | 1.50 | 1.50 | 1.00 |
| CeO₂ | — | 0.50 | — | 0.50 |
| MoO₃ | — | — | 0.50 | 0.50 |
| Sm₂O₃ | 1.00 | — | 2.00 | 1.00 |
| Yb₂O₃ | | 2.00 | | 1.00 |
| SnO₂ | 0.20 | 0.20 | 0.20 | 0.20 |
| L* | 96.5 | 96.5 | 96.3 | 96.4 |
| a* | −0.1 | −0.1 | −0.1 | −0.2 |
| b* | 0.7 | 0.8 | 1.1 | 1.1 |
| C* (Chroma) | 0.7 | 0.8 | 1.1 | 1.1 |
| h^{o} (Hue) | 98 | 97 | 95 | 100 |
| WL^{50%} 0.7 mm | 319 | 340 | 325 | 342 |
| T^{1064 nm} 0.7 mm | 89.47% | 91.46% | 87.15% | 89.27% |

The following parameters are derived from the measured transmission spectra at room temperature for a glass sample of thickness, d, for each example:

the color parameters L* (the lightness), a* (green/red axis value) and b* (blue/yellow axis value) according to the Cartesian coordinates of the CIELAB system, in which the color location of the colored glass is best expressed, and of course for the standard light D65 and the 10° standard observation and the chroma value C* (color saturation) and the color angle h° (color shade) corresponding to the associated polar coordinates of the CIELAB system;

the wavelength WL^{50%} 0.7 mm, at which a transmission value of 50% is observed; and

the transmission T^{1064nm} 0.7 mm at 1064 nm.

From example 2 it is apparent that only doping with samarium oxide produces a significant decrease in the transmission at 1064 nm and thus leads to an increase of the absorption according to equation 1. Only the doping with samarium oxide leads to an absorption band at 1064 nm. Other rare earth oxides do not absorb in this range. In the Table 1 the amounts of samarium oxide of examples 1 to 4 are respectively, 1, 0, 2, 1 in % by weight. The limiting factors are the false colors due to the yellowing of the glass (yellow glass) and the batch cost. As the color parameters a*, b* and C* in Table I show the glass of examples 1 to 4 is largely colorless.

Glass samples of the composition according to Table I were separately tested with a Nd:YAG laser according to the MBLA cutting method. Very rapid heating of the cutting line could be observed, i.e. the glass samples could be cut rapidly and had good cutting properties. In spite of the small glass thickness of the low-expanding alkali-free glass the cut edge was of very good quality without observable micro-cracks, shell or ear-like elements, or glass splitter.

In a further series of tests four further examples of glasses (examples 5 to 8) of the invention were prepared with the compositions according to Table II below. The glass of example 9 was (undoped) TFT glass and was included for comparison purposes in the tests.

Sample sheets with dimensions 130 mm*65*mm*0.7 mm were poured from the pouring block. The transmission spectra of these sheets were measured at room temperature. The following color and other parameters were derived from the transmission spectra and are listed in Table II.

The Ti indicates the “internal” transmission, which was calculated from the measured transmission values with the following correction for reflection losses according to equation (2):
Ti=T/P with P=2n/(n²+1), (2),
wherein n is the index of refraction.

The sheets were then cut with the laser according to the MBLA method. The attained maximum cutting speed or rate in mm/min was recorded using radiation of a wavelength of 1064 nm (Vₘₐₓ^{1064 nm}) and using radiation of a wavelength of 1030 nm (Vₘₐₓ^{1030 nm}). The undoped comparative glass (example 9) could not be cut with the selected adjustments (Vₘₐₓ=0), even after increasing the laser power to 750 watt. The glasses doped with Sm₂O₃ (Examples 5 to 8) could in contrast be cut with a laser power of 500 watt with higher cutting rate. This is successful even with

TABLE II
FLAT GLASS COMPOSITIONS AND PROPERTIES

| | Example 5 | Example 6 | Example 7 | Example 8 | Example 9 |
|---|---|---|---|---|---|
| SiO₂ | 61.30 | 60.90 | 60.40 | 59.40 | 61.40 |
| B₂O₃ | 8.20 | 8.20 | 8.20 | 8.20 | 8.20 |
| Al₂O₃ | 16.00 | 16.00 | 16.00 | 16.00 | 16.00 |
| MgO | 2.80 | 2.80 | 2.80 | 2.80 | 2.80 |
| CaO | 7.90 | 7.90 | 7.90 | 7.90 | 7.90 |
| BaO | 3.40 | 3.40 | 3.40 | 3.40 | 3.40 |
| Sm₂O₃ | 0.10 | 0.50 | 1.00 | 2.00 | 0.00 |
| SnO₂ | 0.30 | 0.30 | 0.30 | 0.30 | 0.30 |
| L* | 96.56 | 96.56 | 96.57 | 96.56 | 96.63 |
| a* | −0.09 | −0.1 | −0.12 | −0.17 | 0.02 |
| b* | 0.31 | 0.36 | 0.47 | 0.63 | 0.24 |
| C* (Chroma) | 0.32 | 0.38 | 0.48 | 0.66 | 0.24 |
| h^{o} (hue) | 105.6 | 105.6 | 104.1 | 104.9 | 86.0 |
| WL^{50%} | 308 | 304 | 303 | 303 | 292 |
| 0.7 mm | | | | | |
| T^{1030 nm} | 0.981 | 0.981 | 0.980 | 0.977 | 0.995 |
| 0.7 mm | | | | | |
| T^{1054 nm} | 0.978 | 0.972 | 0.962 | 0.940 | 0.995 |
| 0.7 mm | | | | | |
| Vₘₐₓ^{1030 nm} | 1000 | 1600 | 1500 | 1700 | 0 |
| T | | | | | |
| Vₘₐₓ^{1064 nm} | 1400 | 2100 | 2300 | 3000 | 0 |
| T | | | | | |

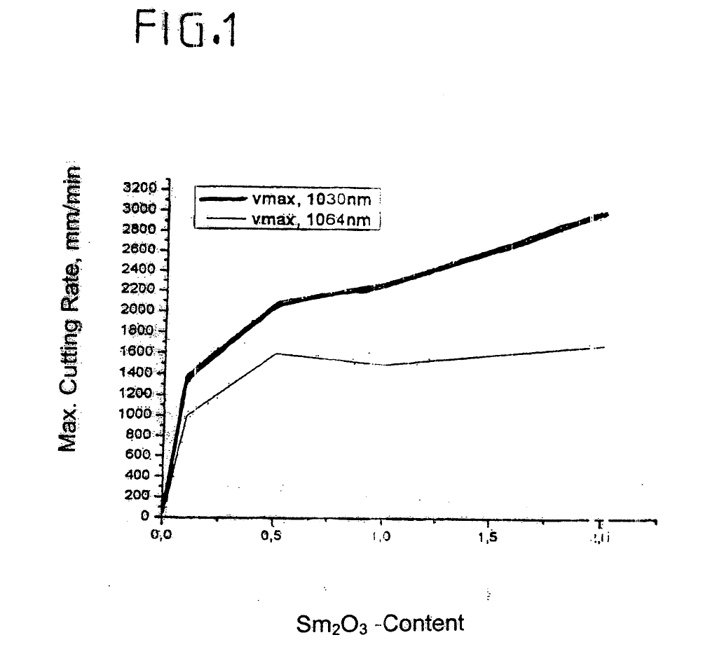

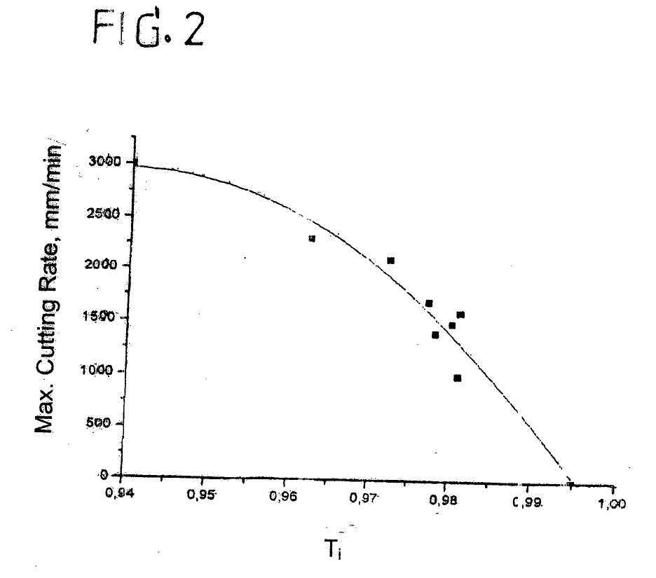

a small doping of only 0.1 weight percent of Sm₂O₃ (Example 5). Even higher cutting rates could be attained with larger amounts of Sm₂O₃. The dependence of the maximum cutting rate on Sm₂O₃ content is illustrated in FIG. 1. The upper curve indicates that dependence for a wavelength of 1064 nm. The effect of the internal transmission Ti on the achievable maximum cutting speed is demonstrated in FIG. 2. The internal transmission values of the undoped glass (not including the Sm₂O₃) in the working wavelength regions (1030 or 1064 nm) were about 0.995, which is insufficient for coupling laser power into the glass. The coupling of laser power into the doped glass was successful at internal transmission values of less than 0.985 and the glass is successfully cut.

A further aspect of the present invention consists in the addition of titanium dioxide and/or cerium dioxide to the flat glass to block UV radiation. The UV absorption edge, characterized by the WL^{50%} 0.7 mm value is shifted to longer wavelengths, i.e. the damaging UV radiation cannot pass through the flat glass. This has advantages in a few applications, in which long-term material stability is needed. Especially organic compounds can degrade by long duration exposure to UV radiation.

The doping of flat glass with Sm₂O₃, TiO₂, or CeO₂ generally leads to a more or less yellow impression or coloring, which can lead to false color shades in displays. On account of the comparatively small amounts of the doping material and the small glass thickness these color effects are negligible, as the small chroma values of the exemplary glass indicate.

The thickness of the thin flat glass is in the millimeter size range, preferably in a range of 12 mm to 0.2 mm. The invention provides a special cutting technique for specially doped borosilicate glasses in connection with the MLBA cutting method, which allows stacked glasses, e.g. spaced apart display sheets for display screens of mobile telephones or correspondingly thick flat glass to be cut in a single working step without the subsequent breaking and processing steps of the prior art.

In the following claims the term “samarium oxide” means Sm₂O₃.

While the invention has been illustrated and described as embodied in a thin flat glass for display purposes and method of cutting the thin flat glass into display sheets, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A thin flat glass for display purposes, said thin flat glass having a glass composition comprising a base glass composition and at least one additive ingredient, said at least one additive ingredient effectively absorbing radiation at a wavelength of 1.064 μm, so as to improve cutting properties of the flat glass for cutting by a laser cutting beam.

2. The thin flat glass as defined in claim 1, wherein said at least one additive ingredient is samarium oxide (Sm₂O₃).

3. The thin flat glass as defined in claim 2, containing from 0.001 to 5 percent by weight of said samarium oxide.

4. The thin flat glass as defined in claim 1, and consisting of an alkali-free glass.

5. The thin flat glass as defined in claim 3, which is free of alkali metals and has a composition, in percent by weight on the basis of oxide content, of:

| | |
|---|---|
| SiO₂ | 40 to 70 |
| Al₂O₃ | 6 to 25 |
| B₂O₃ | 5 to 20 |
| MgO | 0 to 5 |
| CaO | 0 to 15 |
| SrO | 0 to 10 |
| BaO | 0 to 30 |
| ZnO | 0 to 10 |
| TiO₂ | 0 to 3 |
| CeO₂ | 0 to 2 |
| MoO₃ | 0 to 1 |
| Yb₂O₃ | 0 to 2 |
| Sm₂O₃ | 0.001 to 5. |

6. The thin flat glass as defined in claim 1, comprising an additional additive ingredient and wherein said additional additive ingredient is at least one of titanium dioxide and cerium dioxide.

7. The thin flat glass as defined in claim 6, containing from 1 to 2 percent by weight of said titanium dioxide and from 0.5 to 1 percent by weight of said cerium dioxide.

8. The thin flat glass as defined in claim 1, having a thickness on the order of one or more mm.

9. The thin flat glass as defined in claim 1, having a thickness of from 0.2 mm to 12 mm.

10. A method of cutting through a flat glass sheet for an electronic display device, said flat glass sheet having a composition including at least one additive ingredient, said at least one additive ingredient effectively absorbing radiation at a wavelength of 1.064 μm, said method comprising the steps of:
a) focusing radiation of a Nd:YAG laser to form focused laser radiation; and
b) cutting the flat glass sheet with the focused laser radiation from the Nd:YAG laser.

11. The method as defined in claim 10, wherein the cutting of the flat glass sheet comprises a multiple laser beam absorption (MBLA) method of using the laser radiation.
